(19) United States
(12) Patent Application Publication
(10) Pub. No.: US 2023/0211575 A1
(43) Pub. Date: Jul. 6, 2023

(54) SKIN MATERIAL, INTERIOR MATERIAL, AND METHOD FOR MANUFACTURING INTERIOR MATERIAL

(71) Applicant: TOYOTA BOSHOKU KABUSHIKI KAISHA, Aichi (JP)

(72) Inventors: Tsuyoshi YAMAGUCHI, Aichi-ken (JP); Yoshiaki TOUMASU, Aichi-ken (JP)

(73) Assignee: TOYOTA BOSHOKU KABUSHIKI KAISHA, Aichi (JP)

(21) Appl. No.: 17/928,442

(22) PCT Filed: Apr. 1, 2021
(86) PCT No.: PCT/JP2021/014246

§ 371 Date: Nov. 29, 2022

(30) Foreign Application Priority Data
Jun. 3, 2020 (JP) 2020-097228

(51) Int. Cl. B32B 3/04; B32B 3/30; D04B 21/14; B60R 13/02

(52) U.S. Cl. CPC B32B 3/04; B32B 3/30; B60R 13/02; D04B 21/14; B32B 2250/02; B32B 2605/003; B32B 2605/08; B32B 2605/10

(57) ABSTRACT

For the purpose of providing a skin material that is easily bonded to a base material, an interior material including the skin material, and a method for manufacturing the interior material, a skin material includes a base cloth layer and a design layer. The base cloth layer includes a surface fabric and a back fabric, and a binding yarn that binds the surface fabric and the back fabric. The binding yarn is erected between the surface fabric and the back fabric to form a void inside the base cloth layer. An embossed pattern is formed in a concave shape on the skin material from the design layer side. A thin portion is formed in a band shape in a peripheral edge portion of the skin material. The skin material is bonded to the base material to obtain an interior material.

### TECHNICAL FIELD

The present invention relates to a skin material having an embossed pattern formed on a design surface, an interior material having the skin material, and a method for manufacturing the interior material.

### BACKGROUND ART

An interior material used in a vehicle or the like includes a skin material and a base material to which the skin material is bonded, for the purpose of improvement in design property by the skin material. Usually, as the skin material, a material in which a foamed resin such as foamed urethane is bonded to a back of leather, cloth, or the like is used. However, this normal skin material does not provide a sufficient three-dimensional effect when a three-dimensional design such as an embossed pattern is provided.

In addition to a normal skin material, a skin material as described in Patent Literature 1 is known. The skin material includes a base cloth layer and a design layer, and a surface of the design layer is used as a design surface. The base cloth layer is made of a knitted cloth, and has a concave thermally-deformable portion on the surface on the design surface side. The design layer has a three-dimensional pattern by the thermally-deformable portion on the design surface by following a shape of the thermally-deformable portion of the base cloth layer.

### CITATIONS LIST

### Patent Literature

Patent Literature 1: JP 2017-213865 A

### SUMMARY OF INVENTION

### Technical Problems

In the skin material described above, the knitted cloth is used in the base cloth layer, and thus fiber waste is generated when the skin material is cut so that it has a shape according to the interior material. Therefore, in the skin material, a peripheral edge portion including a cut surface is wound up to a back surface opposite to the design surface so that the design surface is not contaminated with the fiber waste. However, in the skin material, the knitted cloth is rich in elasticity and has repulsion, and thus it is difficult to wind the peripheral edge portion, and an operation of bonding the skin material to the base material is complicated.

The present invention has been made in view of the above circumstances, and an object thereof is to provide a skin material that is easily bonded to a base material, an interior material including the skin material, and a method for manufacturing the interior material.

### Solutions to Problems

To solve the above problems, the present invention is presented as follows.

The skin material according to claim 1 is a skin material comprising: a base cloth layer; and a design layer,
wherein the base cloth layer includes a surface fabric and a back fabric, and a binding yarn that binds the surface fabric and the back fabric,
wherein the binding yarn is erected between the surface fabric and the back fabric to form a void inside the base cloth layer,
wherein an embossed pattern is formed in a concave shape from the design layer side, and
wherein a thin portion is formed in a band shape in a peripheral edge portion.

The invention according to claim 2 relates to the skin material according to claim 1,
wherein the design layer includes an outer layer and an inner layer,
wherein the inner layer is a foam layer, and
wherein the design layer is joined to the surface fabric of the base cloth layer via the inner layer.

The invention according to claim 3 relates to the skin material according to claim 1 or 2, wherein the base cloth layer is a double raschel knitted cloth.

The interior material according to claim 4 is an interior material comprising: the skin material according to any one of claims 1 to 3; and a base material to which the skin material is bonded,
wherein the skin material includes: a covering portion covering one surface of the base material in a state of being bonded to the base material; a winding portion wound from one surface side up to another surface side of the base material and disposed on the another surface; and a bent portion provided between the covering portion and the winding portion, and
wherein the bent portion includes the thin portion.

The method for manufacturing an interior material according to claim 5 is a method for manufacturing an interior material including the skin material according to any one of claims 1 to 3 and a base material to which the skin material is bonded, the method comprising:
a processing step of forming the skin material; and
a bonding step of bonding the skin material to the base material,
wherein the processing step is a step of heat-pressing the base cloth layer and the design layer in a stacked state in a thickness direction to form the embossed pattern and the thin portion, and
wherein the bonding step includes: an arrangement step of arranging the skin material on one surface of the base material such that the base cloth layer of the skin material is on the one surface side of the base material; and a winding step of winding the peripheral edge portion up to another surface side of the base material, and
wherein the winding step is performed by bending a site including the thin portion in the peripheral edge portion toward the another surface side of the base material.

### Advantageous Effects of Invention

The present invention can provide a skin material that is easily bonded to a base material, an interior material including the skin material, and a method for manufacturing the interior material.

### BRIEF DESCRIPTION OF DRAWINGS

The present invention will be further described in the following detailed description with reference to the following figures, given non-limiting examples of exemplary embodiments according to the present invention, and like reference symbols represent identical parts through several figures.

FIG. 1(a) is a perspective view, FIG. 1(b) is a cross-sectional view taken along an instruction line 1B-1B in FIG. 1(a), and FIG. 1(c) is a cross-sectional view taken along an instruction line 1C-1C in FIG. 1(a), for explaining a skin material.

FIG. 2(a) is a perspective view and FIG. 2(b) is a cross-sectional view taken along an instruction line 2B-2B in FIG. 2(a), for explaining an interior material.

FIG. 3 is a perspective view explaining a state where an upper platen used in a processing step is viewed from a bottom surface side.

FIG. 4 is a cross-sectional view explaining a first step of the processing step.

FIG. 5 is a perspective view explaining a state where a jig used in the processing step is viewed from an upper surface side.

FIG. 6 is a cross-sectional view explaining a second step of the processing step.

FIG. 7 is a perspective view explaining an arrangement step in a bonding step.

FIG. 8 is a perspective view explaining a winding step in the bonding step.

### DESCRIPTION OF EMBODIMENTS

Hereinafter, the present invention will be described in detail with reference to the drawings.

The particulars described herein are given by way of example and for the purpose of illustrative discussion of the embodiments of the present invention, and are presented for the purpose of providing what is believed to be the description from which the principles and conceptual features of the present invention can be most effectively and readily understood. In this regard, no attempt is made to show structural details of the present invention in more detail than is necessary for the fundamental understanding of the present invention, and the description is taken with the drawings making apparent to those skilled in the art how several forms of the present invention may be embodied in practice.

### Skin Material

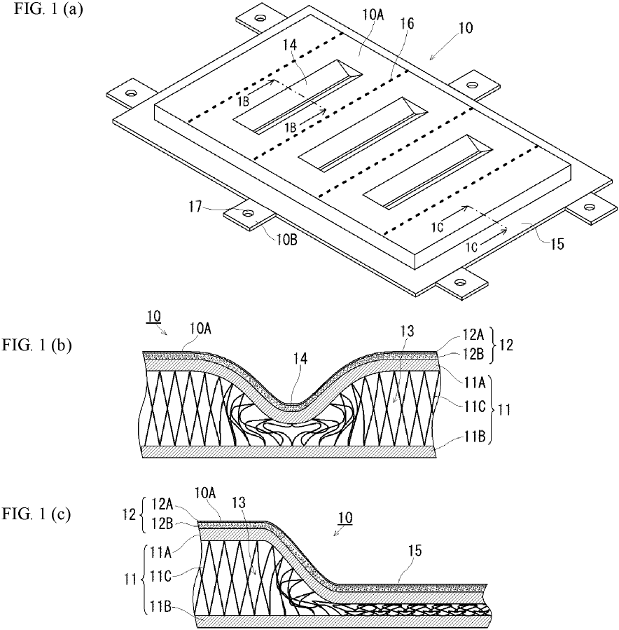

As shown in FIGS. 1(a) to 1(c), a skin material 10 of the present invention includes a base cloth layer 11 and a design layer 12.

The base cloth layer 11 includes a surface fabric 11A and a back fabric 11B, and a binding yarn 11C that binds the surface fabric 11A and the back fabric 11B.

The binding yarn 11C is erected between the surface fabric 11A and the back fabric 11B to form a void 13 inside the base cloth layer 11.

In the skin material 10, an embossed pattern 14 is formed in a concave shape from the design layer 12 side.

A thin portion 15 is formed in a band shape in a peripheral edge portion of the skin material 10.

The base cloth layer 11 is intended to improve texture such as touch feeling and bulkiness by imparting cushioning property to the skin material 10.

The base cloth layer 11 is not particularly limited as long as it has a configuration including the surface fabric 11A, the back fabric 11B, and the binding yarn 11C.

A thickness of the base cloth layer 11 is not particularly limited. For example, the thickness can be preferably from 1 to 20 mm, and more preferably from 2 to 10 mm.

A knit fabric is usually used in the base cloth layer 11.

The knit fabric can impart a suitable cushioning property to the skin material 10. The knit fabric can improve a design property of the skin material 10 by imparting a three-dimensional effect to the embossed pattern 14.

A knitted shape of the knit fabric is not particularly limited. Examples of the knitted shape include a three-dimensional knitted fabric, a jersey, and a tricot. Among them, the three-dimensional knitted fabric is preferred because it is bulky and can impart a suitable three-dimensional effect to the embossed pattern 14. Specifically, this three-dimensional knitted fabric can be knitted by a knitting machine such as a double raschel knitting machine or a circular knitting machine. Among them, a three-dimensional knitted fabric knitted by the double raschel knitting machine (hereinafter, referred to as “double raschel knitted cloth”) can impart a good cushioning property to the skin material 10, and can impart a clear and remarkable three-dimensional effect to the embossed pattern 14.

The surface fabric 11A and the back fabric 11B are not particularly limited. Examples of the surface fabric 11A and the back fabric 11B include fabrics such as a knitted cloth, a woven fabric, and a nonwoven fabric, and a foam sheet. Normally, when a double raschel knitted cloth is used in the base cloth layer 11, a knitted cloth is used in the surface fabric 11A and the back fabric 11B.

A type of knitted cloth is not particularly limited. Examples of the type of knit fabric include warp knit, chain knit, inlaid knit, denbigh knit, cord knit, atlas knit, double denbigh knit, half knit, satin knit, velvet knit, queens cord knit, rib knit, purl knit, plain knit, interlock knit, fraise knit, Mockrody knit, ponte knit, three-hole ponte knit, milano rib knit, single pique knit, double pique knit, triple pique knit, cross miss knit, and brush interlock knit. Among them, the double denbigh knit, the half knit, the cord knit, the brush interlock knit, and the like are preferred as the knitted clothes used in the surface fabric 11A and the back fabric 11B.

A structure of the knitted cloth is not particularly limited. Examples of the structure include a plain structure and a mesh structure.

The knitted clothes used in the surface fabric 11A and the back fabric 11B are preferably knitted clothes having a structure without gaps to such an extent that yarns of a lower layer are not visually recognized, that is, knitted clothes not having a mesh-shaped or net-shaped structure (having a non-mesh-shaped structure or a non-net-shaped structure). The non-mesh-shaped structure or the non-net-shaped structure can prevent the binding yarn 11C from appearing on the embossed pattern 14, which is preferred.

Fibers used in the surface fabric 11A and the back fabric 11B are not particularly limited. Examples of the fibers include synthetic fibers, regenerated fibers, and natural fibers. Usually, synthetic fibers are used as the fibers.

The same fibers may be used in the surface fabric 11A and the back fabric 11B, or different fibers may be used.

Specific examples of the synthetic fibers include thermoplastic resin fibers including polyester fibers such as polyethylene terephthalate fiber, polybutylene terephthalate fiber, and polytrimethylene terephthalate fiber; polyamide fibers such as nylon 6 fiber and nylon 66 fiber; polyacrylic fibers; and polyolefin fibers such as polyethylene fiber and polypropylene fiber, and synthetic fibers other than such thermoplastic resin fibers. These synthetic fibers may be used singly, or two or more types thereof may be used in combination.

The binding yarn 11C is intended for imparting unique cushioning property, bulkiness, elasticity, shape restoring property, and the like to the base cloth layer 11.

That is, the binding yarn 11C is erected between the surface fabric 11A and the back fabric 11B to form the void 13 inside the base cloth layer 11.

The binding yarn 11C warps to withstand a force acting on the base cloth layer 11 (skin material 10) from the thickness direction. When the force acting from the thickness direction is lost, the binding yarn 11C returns to the original shape to restore the shape of the base cloth layer 11.

The binding yarn 11C is not particularly limited in terms of the fibers to be used.

Specific examples of the fiber include thermoplastic resin fibers including polyester fibers such as polyethylene terephthalate fiber, polybutylene terephthalate fiber, and polytrimethylene terephthalate fiber; polyamide fibers such as nylon 6 fiber and nylon 66 fiber; polyacrylic fibers; and polyolefin fibers such as polypropylene fiber. Further, in addition to the thermoplastic resin fibers, natural fibers such as cotton, hemp, silk, and wool, and regenerated fibers such as cupra rayon, viscose rayon, and lyocell are exemplified.

The binding yarn 11C preferably contains the thermoplastic resin fibers exemplified above. This is because the binding yarn 11C contains thermoplastic resin fibers, and thus can undergo thermal deformation such as heat shrinkage, heat melting, or heat setting, and, therefore, the embossed pattern 14 can be formed by heat-pressing.

Among the thermoplastic resin fibers, polyester fibers, particularly polyethylene terephthalate, polytrimethylene terephthalate, and polybutylene terephthalate fibers are more preferred.

The binding yarn 11C can contain thermally fusible fibers. When containing the thermally fusible fibers, the binding yarn 11C can suitably maintain the shape after thermal deformation.

A form of the binding yarn 11C is not particularly limited. When the binding yarn 11C contains thermoplastic resin fibers, a filament yarn such as a multifilament yarn or a monofilament yarn is usually used.

The filament yarn can be used as a highly crimped yarn, a false-twisted yarn, a textured yarn such as a fluid jet textured yarn, or a mixed yarn obtained by mixing two or more types of fibers. Among them, highly crimped yarns are preferred because they can impart a good cushioning property to the skin material 10.

Fineness of the binding yarn 11C is not particularly limited. For example, the fineness can be preferably from 10 to 1500 decitex, more preferably from 20 to 1000 decitex, and still more preferably from 20 to 350 decitex.

A yarn density of the binding yarn 11C is not particularly limited. For example, the yarn density can be preferably from 10 to 100 yarns/inch, and more preferably from 15 to 70 yarns/inch in a course direction, and preferably from 5 to 50 yarns/inch, and more preferably from 8 to 30 yarns/inch in a wale direction.

The design layer 12 is disposed on the surface fabric 11A side of the base cloth layer 11 to decorate a design surface 10A of the skin material 10, thereby improving design property and texture. That is, the surface of the design layer 12 serves as the design surface 10A of the skin material 10.

The design surface 10A exerts a high aesthetic appearance due to the embossed pattern 14 and, further, a stitch pattern 16 formed thereon, so that the design property of the skin material 10 is improved.

A configuration of the design layer 12 is not particularly limited. The design layer 12 may have only one layer or two or more layers.

The design layer 12 can have a surface layer 12A and an inner layer 12B, that is, can have two or more layers, from the viewpoint of improving design property and improving durability against scratches (see FIG. 1(b)).

The surface layer 12A is a layer on an outer side of the design layer 12, which forms the design surface 10A. A surface protective layer such as a topcoat layer can be further provided on a surface of the surface layer 12A.

A material for the surface layer 12A is not particularly limited. As the material, a design cloth (fabric), a resin layer (PU, PVC, PP, etc.), synthetic leather, artificial leather, natural leather, and the like are exemplified.

A thickness of the surface layer 12A is not particularly limited. For example, the thickness can be preferably from 0.01 to 10 mm, and more preferably from 0.1 to 5 mm.

The inner layer 12B is a layer that joins the design layer 12 to the surface fabric 11A of the base cloth layer 11.

The inner layer 12B is not particularly limited, and can be provided, for example, by applying an adhesive.

The inner layer 12B is preferably a foam layer.

The foam layer is a resin layer containing bubbles formed by foaming. That is, cell walls separating the bubbles in the foam layer from each other are formed of resin. The bubbles constituting the foam layer may be open cells, but are preferably closed cells.

The type of resin constituting the foam layer is not limited, and a polyurethane resin, a polyolefin resin, a polyvinyl chloride resin, a polystyrene resin, a polyamide resin, a urethane elastomer, a thermoplastic elastomer, or the like can be used. These may be used singly, or two or more thereof may be used in combination.

Among these, the foam layer is preferably a foamed polyurethane layer formed by laminate molding. That is, a foamed polyurethane layer formed by foaming a urethane adhesive is preferred.

The embossed pattern 14 is formed in a concave shape from the design surface 10A side with respect to the skin material 10. The embossed pattern 14, alone or in combination, constitutes a three-dimensional design composed of a three-dimensional pattern.

As shown in FIG. 1(b), at a place where the embossed pattern 14 is formed, the binding yarn 11C undergoes thermal deformation or the like and is in a state of falling down between the surface fabric 11A and the back fabric 11B. The binding yarn 11C in this state pulls the surface fabric 11A into the base cloth layer 11 and narrows the void 13 in the thickness direction.

By following the shape of the surface fabric 11A, the design layer 12 recesses the design surface 10A to form the embossed pattern 14.

A number of the embossed patterns 14 is not particularly limited. For example, in FIG. 1(a), three embossed patterns 14 are formed on the design surface 10A, but the number of the embossed patterns 14 may be one or two, or may be four or more.

A shape of the embossed pattern 14 is not particularly limited as long as the embossed pattern 14 is formed in a concave shape on the design surface 10A. For example, this shape is a rectangular shape in plan view in FIG. 1(a), but may be a circular shape, a polygonal shape such as a triangular shape, a pentagonal shape, or a hexagonal shape, a wave pattern, a seam shape, or the like in plan view.

A depth (thickness) of the embossed pattern 14 in the thickness direction of the skin material 10 is not particularly limited. For example, in FIG. 1(a), all the embossed patterns 14 are formed so as to have the same depth, but may be formed so as to have different depths.

The thin portion 15 is formed over an entire outer periphery in the peripheral edge portion of the skin material 10.

As illustrated in FIG. 1(c), at a place where the thin portion 15 is formed, the binding yarn 11C undergoes thermal deformation or the like and is in a crushed state between the surface fabric 11A and the back fabric 11B. The binding yarn 11C in this state cannot exhibit the above-described cushioning property, bulkiness, elasticity, shape restoring property, or the like, as compared with its state of being erected between the surface fabric 11A and the back fabric 11B. However, the base cloth layer 11 still retains flexibility due to the surface fabric 11A, the back fabric 11B, and the like. Therefore, the thin portion 15 is weakened in elasticity as compared with other places of the skin material 10, and is thus easily bent.

A thickness of the thin portion 15 is not particularly limited. For example, the thickness of the thin portion 15 can be preferably from ⅔ to ⅕, and more preferably from ¼ to ⅕ of the thickness of the skin material 10.

A shape of the thin portion 15 in plan view is not particularly limited. For example, in FIG. 1(a), the thin portion 15 is formed in a frame shape in plan view, but may be formed linearly at left and right or upper and lower side edge portions.

The thin portion 15 is formed in a band shape, but a band width thereof is not particularly limited. For example, the band width can be preferably from 10 to 50 mm, and more preferably from 15 to 50 mm in length from an outer edge of the skin material 10.

The embossed pattern 14 and the thin portion 15 are formed such that the thermally deformed binding yarn 11C narrows the void 13 in the thickness direction to reduce the thickness of the base cloth layer 11. Usually, the thickness of the design layer 12 in the embossed pattern 14 and the thin portion 15 is substantially the same as the thickness of the design layer 12 in a region where neither the embossed pattern 14 nor the thin portion 15 is formed. In the embossed pattern 14 and the thin portion 15 of such an aspect, the effect of the present invention can be more effectively obtained.

More specifically, when a thickness of the design layer 12 is D_{12A} and a thickness of the base cloth layer 11 is D_{11A} in a portion where neither the embossed pattern 14 nor the thin portion 15 is formed (region not heated or pressed), and, further, a thickness of the design layer 12 is D_{12B} and a thickness of the base cloth layer 11 is D_{11B} in a portion where, in the embossed pattern 14 and the thin portion 15, the thickness of the skin material 10 is smallest, 0 < D_{11B/}D_{11A} ≤ 0.6, and 0.8 ≤ D_{12B/}D_{12A} ≤ 1.2 can be established. Further, this value can be 0.3 ≤ D_{11B/}D_{11A} ≤ 0.5 and 0.9 ≤ D_{12B/}D_{12A} ≤ 1.1.

As shown in FIG. 1(a), the stitch pattern 16 can be formed on the design surface 10A of the skin material 10. The stitch pattern 16 is formed by sewing a decorative yarn into the skin material 10. The decorative yarn used for the stitch pattern 16 is not particularly limited in terms of color, thickness, type, or the like.

A position where the stitch pattern 16 is formed is not particularly limited. The position of the stitch pattern 16 is preferably determined according to the position of the embossed pattern 14, from the viewpoint of improving appearance quality by synergistic effects with the embossed pattern 14.

In order to determine the position of the stitch pattern 16, a hole 17 can be formed in the peripheral edge portion of the skin material 10.

That is, a plurality of tabs 10B are provided in the peripheral edge portion of the skin material 10. The hole 17 is formed in each of the tabs 10B.

A position of the hole 17 is not particularly limited as long as a relative position between the stitch pattern 16 and the embossed pattern 14 can be determined.

A shape, a size, and the like of the hole 17 are not particularly limited.

### Interior Material

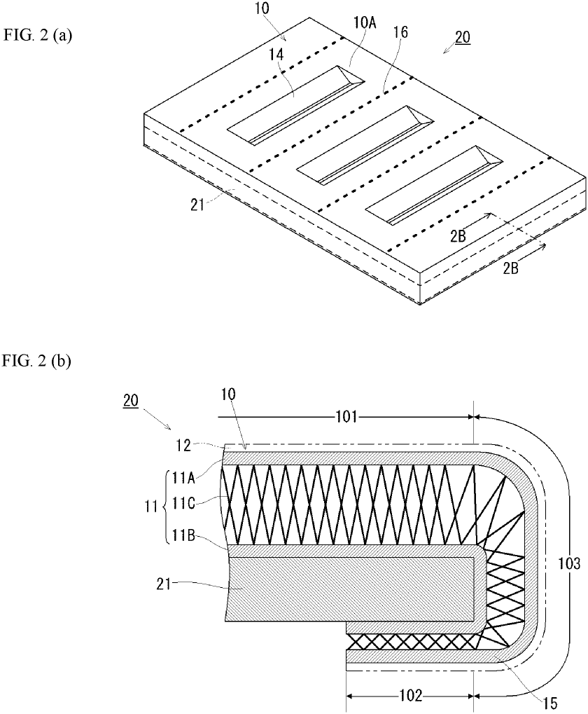

As shown in FIGS. 2(a) and 2(b), an interior material 20 of the present invention includes the skin material 10 and a base material 21 to which the skin material 10 is bonded. That is, the interior material 20 includes the skin material 10 and the base material 21 to which the skin material 10 is pasted.

The skin material 10 includes a covering portion 101 covering one surface of the base material 21 in a state of being bonded to the base material 21, a winding portion 102 wound from one surface side up to another surface side of the base material 21 and disposed on the another surface, and a bent portion 103 provided between the covering portion 101 and the winding portion 102.

The bent portion 103 includes the thin portion 15.

In FIG. 2(b), the skin material 10 is shown in a simplified manner.

That is, in FIG. 2(b), only an outer shape of the design layer 12 is indicated by a two-dot chain line.

In FIG. 2(b), the binding yarn 11C of the base cloth layer 11 is shown in a simplified manner by omitting the detailed shape.

An application of the interior material 20 is not particularly limited. Examples of the application of the interior material 20 include vehicles such as automobiles and railway vehicles, aircrafts, ships, and buildings. Specifically, vehicle interior materials such as a door trim, a roof trim, and a seat are exemplified.

A method for bonding the skin material 10 to the base material 21 is not particularly limited. Examples of the bonding method include known methods such as bonding via an adhesive or the like and thermal fusion.

In addition, any other functional layer such as a sound absorbing layer or an elastic layer can be interposed between the skin material 10 and the base material 21.

The base material 21 is provided to serve as a core of the interior material 20.

A shape of the base material 21 is not particularly limited. For example, the shape of the base material 21 may be a solid body or a hollow body.

A material for the base material 21 is not particularly limited. For example, the material for the base material 21 may be either an organic material or an inorganic material, or may be a composite material containing these materials. Examples of usable organic materials include a thermoplastic resin and a cured resin. Examples of usable inorganic materials include a metal, an alloy, and ceramics.

In the skin material 10, the covering portion 101 is a site appearing on the surface of the interior material 20. That is, the covering portion 101 is a site that improves the design property of the interior material 20 by virtue of the embossed pattern 14 and the like. Therefore, the covering portion 101 does not include the thin portion 15 at all.

The winding portion 102 is a site wound up to the back surface of the interior material 20. That is, the winding portion 102 is an invisible site. Thus, the entire winding portion 102 is formed by the thin portion 15. When the skin material 10 is cut, a cut surface formed at an outer peripheral edge of the skin material 10 is included in the winding portion 102.

The bent portion 103 is a site where the skin material 10 is bent when the winding portion 102 is wound up to the back surface of the interior material 20. That is, the bent portion 103 includes the thin portion 15 which is a site easily bent in the skin material 10 as described above.

Specifically, in the bent portion 103, an inner edge portion on a center side of the skin material 10 is formed by a part (outer edge portion) of the covering portion 101, and an outer edge portion on the peripheral edge side of the skin material 10 is formed by a part (inner edge portion) of the thin portion 15.

### Method for Manufacturing Interior Material

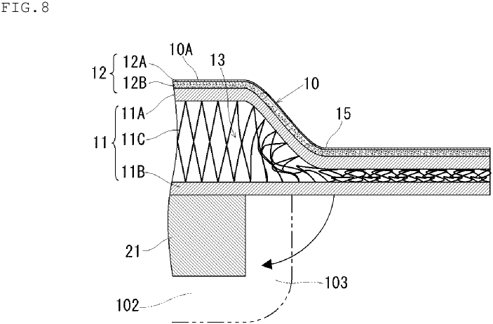

The method for manufacturing the interior material 20 of the present invention includes a processing step of forming a skin material 10, and a bonding step of bonding the skin material 10 to the base material 21 (see FIGS. 7 and 8). That is, the method for manufacturing the interior material 20 of the present invention includes a processing step of forming the skin material 10, and a pasting step of pasting the skin material 10 to the base material 21 (see FIGS. 7 and 8).

As shown in FIG. 4, the processing step is a step of bringing the base cloth layer 11 and the design layer 12 into a stacked state, and heat-pressing them in a thickness direction in this state to form an embossed pattern 14 and a thin portion 15.

The bonding step includes an arrangement step of arranging the skin material 10 on one surface of the base material 21 such that the base cloth layer 11 of the skin material 10 is on the one surface side of the base material (see FIG. 7), and a winding step of winding a peripheral edge portion of the skin material 10 up to another surface side of the base material 21 (see FIG. 8).

Then, the winding step is performed by bending a site including the thin portion 15 at the peripheral edge portion of the skin material 10 toward the another surface side of the base material 21.

The processing step can be performed by heat-pressing using an upper platen 30A and a lower platen 30B.

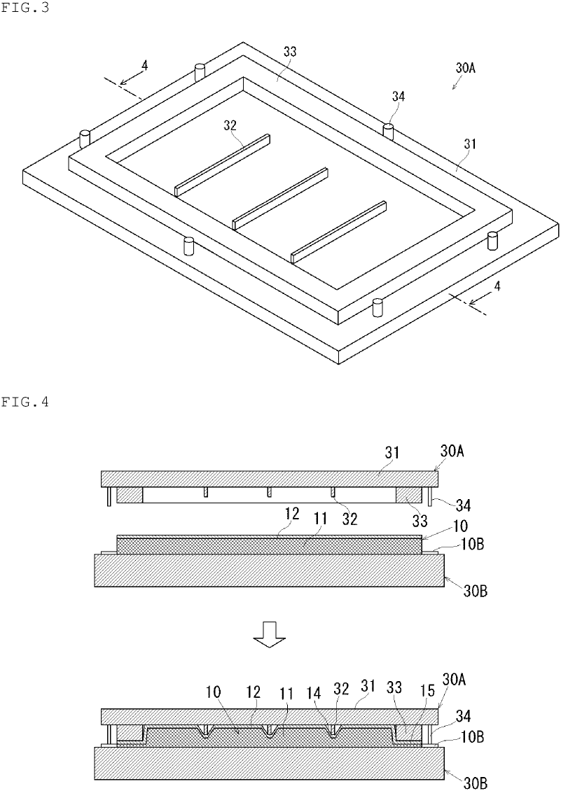

FIG. 3 is a perspective view showing a state where the upper platen 30A is viewed from a bottom surface. Note that FIG. 4 shows a cross-sectional view taken along a 4-4 instruction line in FIG. 3 as the upper platen 30A.

As shown in FIG. 3, in the upper platen 30A, a first rib 32 having a shape according to the embossed pattern 14 is provided at a central portion of a bottom surface of a flat plate-shaped substrate 31.

In the upper platen 30A, a second rib 33 is provided in a peripheral edge portion of the bottom surface of the substrate 31. The second rib 33 is formed in a frame shape so as to correspond to the thin portion 15.

Further, the upper platen 30A is provided with a plurality of piercing pins 34 in the peripheral edge portion of the bottom surface of the substrate 31. The piercing pins 34 are arranged at positions corresponding to tabs 10B.

When heat-pressing is performed, the base cloth layer 11 and the design layer 12 are placed in a stacked state on an upper surface of the lower platen 30B, as shown in FIG. 4.

Then, the upper platen 30A is brought closer from the design layer 12 side, and the base cloth layer 11 and the design layer 12 are heat-pressed between the upper platen 30A and the lower platen 30B.

In the heat-pressing, the binding yarn 11C of the base cloth layer 11 is thermally deformed substantially simultaneously by the first rib 32 and the second rib 33, and then the shape at the time of thermal deformation is fixed by cooling, whereby both the embossed pattern 14 and the thin portion 15 are formed in one step.

In the heat-pressing, holes 17 are formed in the tabs 10B by the piercing pins 34.

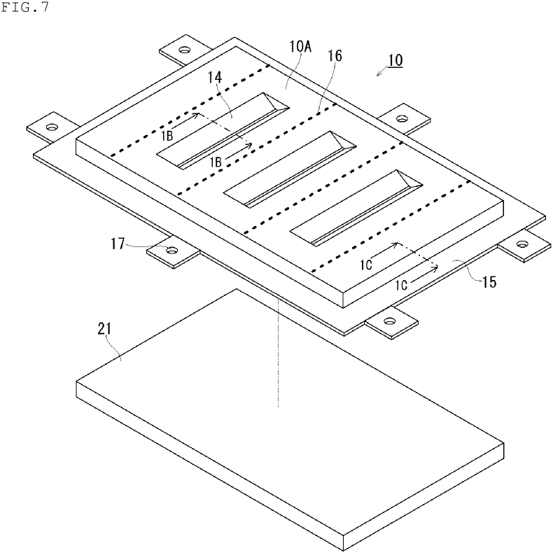

Furthermore, the processing step can include the above step of forming the embossed pattern 14 and the thin portion 15 as a first step, and a second step of forming a stitch pattern 16 (see FIG. 6).

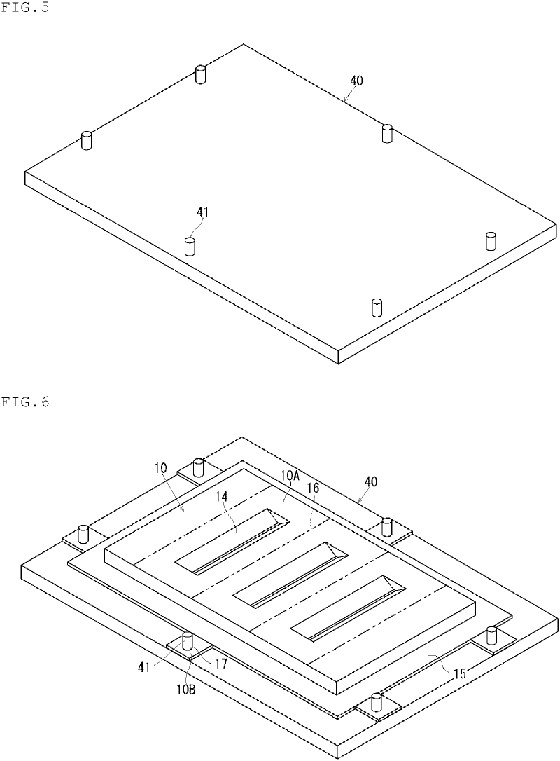

The second step is performed using a jig 40 in which a plurality of fixing pins 41 are provided on an upper surface thereof as shown in FIG. 5. In the jig 40, the plurality of fixing pins 41 are provided such that relative positions thereof are the same as relative positions of the plurality of piercing pins 34 described above.

As shown in FIG. 6, the second step is performed while the holes 17 of the skin material 10 are fixed to the fixing pins 41 of the jig 40. That is, the fixing pins 41 have the same relative positions as the piercing pins 34, and thus a relative position between the stitch pattern 16 and the embossed pattern 14 can be determined by fixing the holes 17 to the fixing pins 41.

As shown in FIG. 7, the arrangement step in the bonding step is performed by overlapping the skin material 10 on the surface of the base material 21.

In this arrangement step, the skin material 10 is disposed such that the thin portion 15 protrudes outward from the peripheral edge of the base material 21.

As shown in FIG. 8, the winding step in the bonding step is performed by bending the peripheral edge portion of the skin material 10 to form a bent portion 103 and further winding the winding portion 102 up to a back surface of the base material 21.

The bending of the peripheral edge portion of the skin material 10 is performed with the thin portion 15 as a reference.

That is, as described above, the thin portion 15 is easily bent since the binding yarn 11C is crushed between the surface fabric 11A and the back fabric 11B. Therefore, the skin material 10 is bent such that the thin portion 15 is included in the bent portion 103, whereby the winding portion 102 can be easily wound up to the back surface of the base material 21 without any resistance.

### INDUSTRIAL APPLICABILITY

The skin material and the interior material of the present invention can be used in various technical fields. Specifically, the present invention can be suitably used in the field related to skin materials in various industries such as vehicles (e.g., automobiles and railway vehicles), aircraft, ships, buildings, and apparel.

### REFERENCE SIGNS LIST

10; Skin material, 10A; Design surface, 10B; Tab
101; Covering portion, 102; Winding portion, 103; Bent portion
11; Base cloth layer, 11A; Surface fabric, 11B; Back fabric, 11C; Binding yarn
12; Design layer, 12A; Surface layer, 12B; Inner layer
13; Void
14; Embossed pattern
15; Thin portion
16; Stitch pattern
17; Hole
20; Interior material
21; Base material
30A; Upper platen, 30B; Lower platen
31; Substrate, 32; First rib, 33; Second rib, 34; Piercing pin
40; Jig
41; Fixing pin.

1. A skin material comprising: a base cloth layer; and a design layer,
wherein the base cloth layer includes a surface fabric and a back fabric, and a binding yarn that binds the surface fabric and the back fabric,
wherein the binding yarn is erected between the surface fabric and the back fabric to form a void inside the base cloth layer,
wherein an embossed pattern is formed in a concave shape from the design layer side, and
wherein a thin portion is formed in a band shape in a peripheral edge portion.

2. The skin material according to claim 1,
wherein the design layer includes an outer layer and an inner layer,
wherein the inner layer is a foam layer, and
wherein the design layer is joined to the surface fabric of the base cloth layer via the inner layer.

3. The skin material according to claim 1, wherein the base cloth layer is a double raschel knitted cloth.

4. An interior material comprising: the skin material according to claim 1; and a base material to which the skin material is bonded,
wherein the skin material includes: a covering portion covering one surface of the base material in a state of being bonded to the base material; a winding portion wound from one surface side up to another surface side of the base material and disposed on the another surface; and a bent portion provided between the covering portion and the winding portion, and
wherein the bent portion includes the thin portion.

5. A method for manufacturing an interior material including the skin material according to claim 1 and a base material to which the skin material is bonded, the method comprising:
forming the skin material; and
bonding the skin material to the base material,
wherein the forming includes heat-pressing the base cloth layer and the design layer in a stacked state in a thickness direction to form the embossed pattern and the thin portion, and
wherein the bonding includes: arranging the skin material on one surface of the base material such that the base cloth layer of the skin material is on the one surface side of the base material; and winding the peripheral edge portion up to another surface side of the base material, and
wherein the winding includes bending a site including the thin portion in the peripheral edge portion toward the another surface side of the base material.
